(19) United States
(12) Patent Application Publication
(10) Pub. No.: US 2009/0103142 A1
(43) Pub. Date: Apr. 23, 2009

(54) Method and apparatus for reducing aliasing artifacts in scans of screen printed originals

(75) Inventors: Aditya Jayant Angal, Lexington, KY (US); Anthony Craig Coleman, Georgetown, KY (US); Anthony Michael King, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/974,989

(22) Filed: Oct. 17, 2007

(51) Int. Cl. G06T 5/00

(52) U.S. Cl. 358/3.26; 358/463; 358/497

(57) ABSTRACT

Method and apparatus of reducing aliasing when scanning a screen printed document including removing high frequency image information at the input of an image sensor prior to scanning. Removing high frequency image information increases the effective sampling frequency of the scanner thereby reducing the effects of aliasing by. Removal of high frequency image information is achieved by adjusting the focal position of the image sensor from a focused position to a defocused position using a mechanism for moving the image sensor or scan bar relative to either the scan bed or a document to be scanned.

### CROSS REFERENCE TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Invention

The present invention is directed to a method of reducing undesirable artifacts in scanned documents and, more particularly, to a method of reducing aliasing in scans of screen printed originals.

2. Description of the Related Art

Aliasing is an undesirable artifact in a scanned document that results from the negative interaction of the screen frequencies of original content with the spatial sampling frequencies of the scanner. Aliasing regularly occurs when screen printed originals, such as magazine covers and the like, are scanned. The result of this interaction is the appearance of a moiré pattern on the completed scan. FIG. 2 shows an example of a scanned screen printed original having aliasing artifacts.

As is known from the Nyquist theorem, aliasing occurs when the original content of the document that is to be scanned, such as a screen printed original, is sampled or scanned at a frequency (fₛ) that is less than twice the highest frequency component (fₕ) of the original content (fₛ<2fₕ). FIGS. 1A-C illustrate the relationship between the highest frequency component of original content and the sampling frequency. FIG. 1A shows the input spectrum of an original content signal with a maximum frequency of fₕ. FIG. 1B, shows the output spectrum after the original content signal has been sampled by a signal of frequency fₛ such that fₛ>2fₕ. No aliasing occurs under these scan conditions.

By way of contrast, FIG. 1C shows the output spectrum after the original content signal has been sampled by a signal fₛ wherein fₛ<2fₕ. Under these conditions aliasing occurs where indicated in FIG. 1C and image data is lost.

The results of aliasing are further illustrated in FIGS. 2 and 3. FIG. 2 shows the visual results of scanning a magazine cover 200 using the standard settings of a contact image sensor (CIS) scanner. The close up view 202 on the lower left shows the artifacts, e.g., the horizontal and vertical lines and banding, present in the image due to aliasing. For purposes of comparison, the close up view 204 on the lower right shows the original content of the image. FIG. 3 contains a Fast Fourier Transform (FFT) 302, 304, respectively of the close up views 202, 204 shown in FIG. 2. A comparison of the FFT data reveals that the scanned image 202 has several additional and undesired artifacts 306 that are not present in the original image.

One solution to the aliasing problem is to increase the sampling frequency by increasing the scan resolution. Once the sampling frequency (fₛ) exceeds twice the highest frequency component (fₕ) of the original content, aliasing is eliminated. While effective at eliminating aliasing, this method has several drawbacks. First, increasing the scan resolution requires the user to alter the scanner driver's advanced settings which may require advanced know-how. Second, increasing the scan resolution can increase the time to complete a scan by a factor of ten or more. Finally, increasing the scan resolution significantly increases the file size of the resultant scan.

Another solution to the aliasing problem involves filtering the scanned image to reduce the effects of the undesired artifacts and thereby mitigate the impact of aliasing. This solution is difficult to implement as it requires specialized software and advanced know-how. Furthermore, this solution does not solve the problem of aliasing but, instead, mitigates the observable effects of aliasing.

Accordingly, a method and apparatus is needed for reducing aliasing in scans of screen printed original documents that can be easily implemented by the end user.

### SUMMARY OF THE INVENTION

The present invention addresses the need for a method and apparatus for reducing aliasing in scans of screen printed original documents that can be easily implemented by the end user. In one aspect, the invention is a method for eliminating aliasing in scans of screen printed original documents by removing high frequency image information at the input of a scanner's image sensor. The removal of high frequency information increases the effective sampling frequency of the scanner thereby reducing the amount of aliasing that occurs. The removal of high frequency information is accomplished by defocusing the image sensor by adjusting about the nominal focal position between the sensor and the document being scanned.

In another embodiment, the method comprises an initial step of performing a pre-scan to determine if the removal of high frequency information will reduce the effects of aliasing.

Another aspect of the invention is a scanner having an apparatus for reducing aliasing in screen printed original documents. The apparatus comprises a scan bar that can be focused and defocused by adjusting about the nominal focal position of the scan bar relative to the document being scanned. When in a defocused position, the scan bar is effective for removing high frequency image information thereby decreasing the amount of aliasing that occurs in the scanned image.

The method and apparatus described herein are advantageous for producing scans of screen printed original documents by reducing the undesirable image artifacts that result from aliasing. Additional advantages will be apparent in light of the detailed description.

### BRIEF DESCRIPTION OF THE DRAWINGS

The patent or application file contains at least one drawing executed in color. Copies of the patent or patent application publication with color drawings will be provided by the Office upon request and payment of the necessary fees.

While the specification concludes with claims particularly pointing out and distinctly claiming the present invention, it is believed the same will be better understood from the following description taken in conjunction with the accompanying drawings in which:

FIG. 1A is a graphical representation in the frequency domain showing a one dimensional input spectrum having a maximum frequency fₕ;

FIG. 1B is a graphical representation of the input spectrum of FIG. 1A after sampling by a signal fₛ such that fₛ<2fₕ;

FIG. 1C is a graphical representation of the input spectrum of FIG. 1B after sampling by a signal fₛ such that fₛ<2fₕ;

FIG. 2 is a color scan of a screen printed original, in this case a magazine cover where the exploded view on the lower left shows the undesirable image artifacts as a result of aliasing and the image on the lower right shows the original content of the image prior to scanning;

FIG. 3 is a log plot of the 2D Fast Fourier Transform (FFT) of the exploded views of FIG. 2 showing the additional, undesirable content due to aliasing;

FIGS. 4A, 4B is a graphical representation in the frequency domain of a one dimensional input spectrum before and after removal of high frequency content;

FIG. 5 is a graph depicting CIS depth of field (in terms of MTF) as a function of the position of the CIS.

FIGS. 6A and 6B respectively show scans of a Spatial Frequency Response (SFR) target taken with the CIS focused (0 mm) and defocused (3 mm);

FIG. 7 is a graph depicting CIS depth of field (in terms of MTF) as a function of the position of the CIS for a frequency content (fₕ) of 75 cycles/in;

FIGS. 8A and 8B contain, respectively, a side by side comparison of scans taken with the CIS focused (0 mm) and the CIS positioned at the experimentally determined defocused depth (2.1 mm);

FIG. 9 is a schematic representation of an apparatus for reducing aliasing in scans of screen printed original documents; and

FIGS. 10A-10E show an exemplary embodiment of an apparatus for reducing aliasing in scans of screen printed original documents.

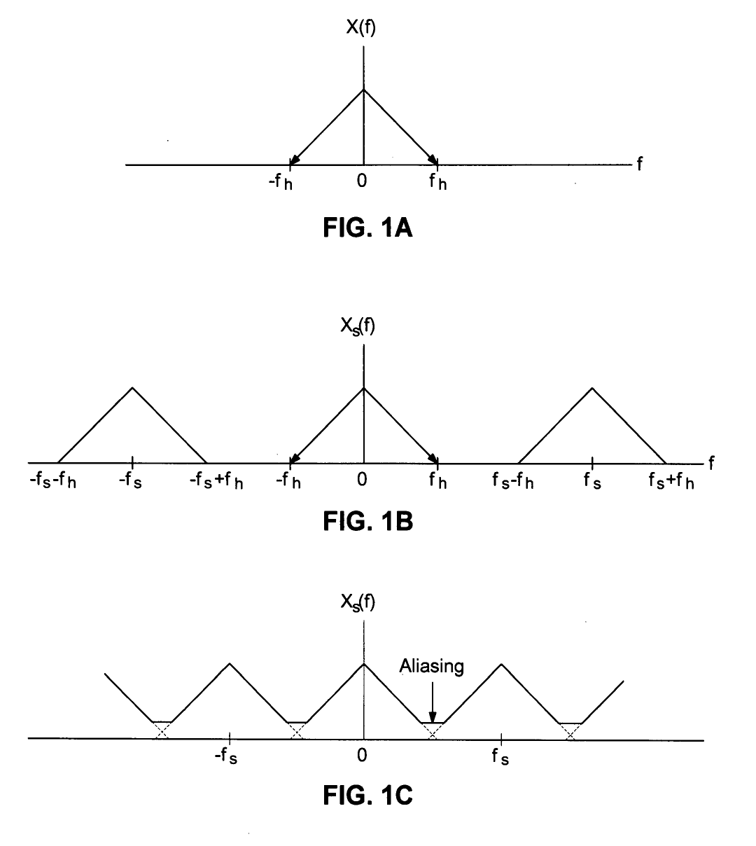

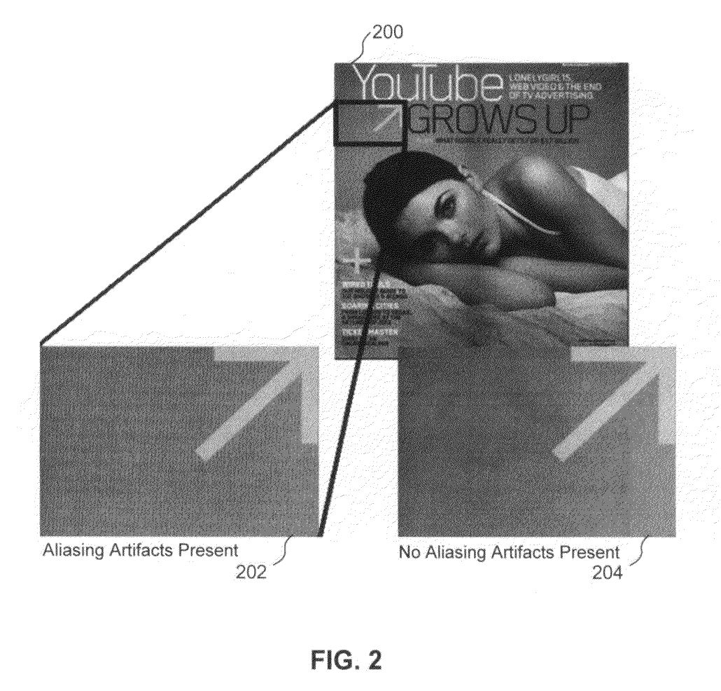

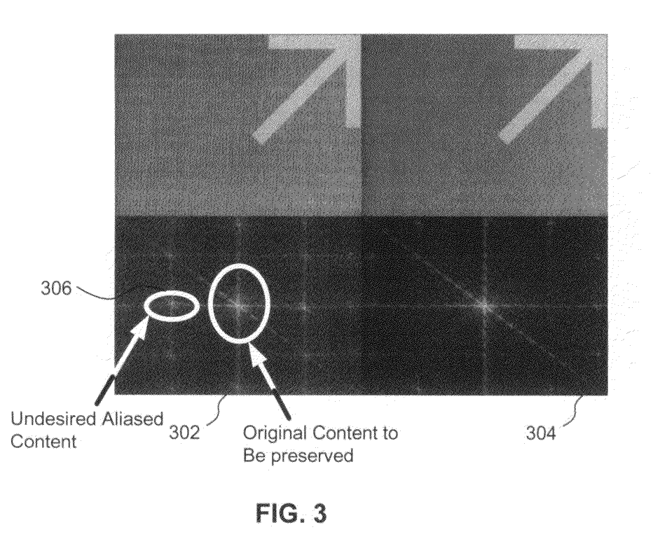

The embodiments set forth in the drawings are illustrative in nature and not intended to limit the inventions defined by the claims. Moreover, the individual features of the drawings and the invention will be more fully apparent and understood in view of the detailed description.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. For purposes of discussion, using an X-Y-Z axis system, the document or portion of document to be scanned would lay in the X-Z plane as would the length scan bar. The scan bar would be focused and defocused by moving it in the Y direction. To scan a document, the scan bar would be moved along the X axis

As discussed hereinabove, the Nyquist theorem indicates that aliasing will occur when the sampling frequency (fₛ) is less than twice the highest frequency content (fₕ) of the original document. Therefore, to prevent aliasing, the sampling frequency must be greater than twice the highest frequency content of the original document. This can be achieved in one of two ways: increasing the actual sampling frequency (e.g. using a greater frequency to sample the image) or increasing the effective sampling frequency by decreasing the highest frequency components of the original. Decreasing the highest frequency components changes the conditions under which aliasing will occur by lowering the value 2fₕ which, in effect, is the same as raising the sampling frequency fₛ.

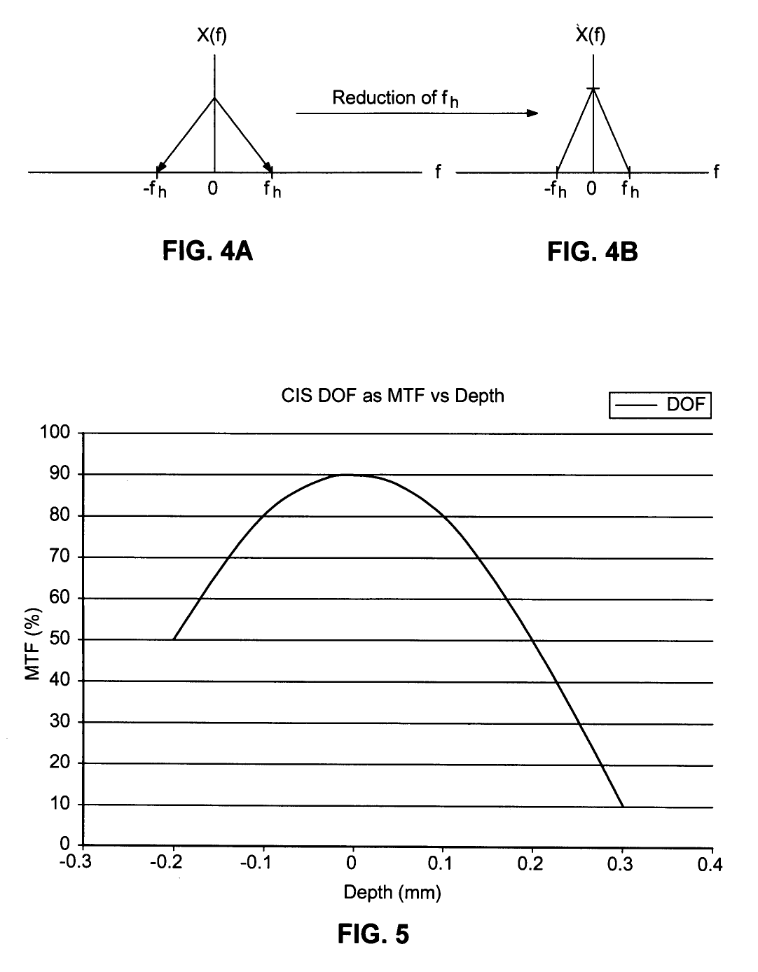

The present method reduces aliasing by increasing the effective sampling frequency of the scanner by removing higher frequency information at the input of the optical sensor through filtering while maintaining lower frequency image information as valid image data. The operative principle of the method is shown in FIGS. 4A, 4B. FIG. 4A shows a one dimensional signal in the frequency domain having a frequency of 2fₕ. FIG. 4B shows the same one dimensional signal after higher frequency information has been removed. Removal of the higher frequency information significantly reduces the value of 2fₕ while maintaining the frequency content that can be correctly sampled without the possibility of aliasing. In this manner a scanned image can be produced without the effects of aliasing and without having to increase the sampling frequency fₛ.

For purposes of the present invention, the removal of high frequency information is accomplished by optically filtering image data obtained from the original document at the input of the optical sensor. Optical filtering is performed by defocusing the image sensor. Defocusing the image sensor blurs the resultant scanned image removing high frequency information and reducing aliasing. Lower frequency image information is preserved as valid image data.

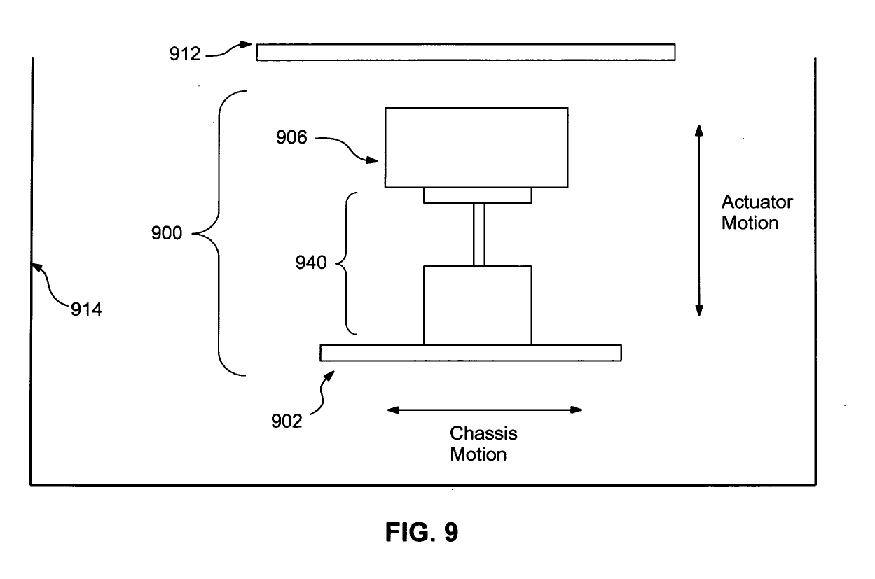

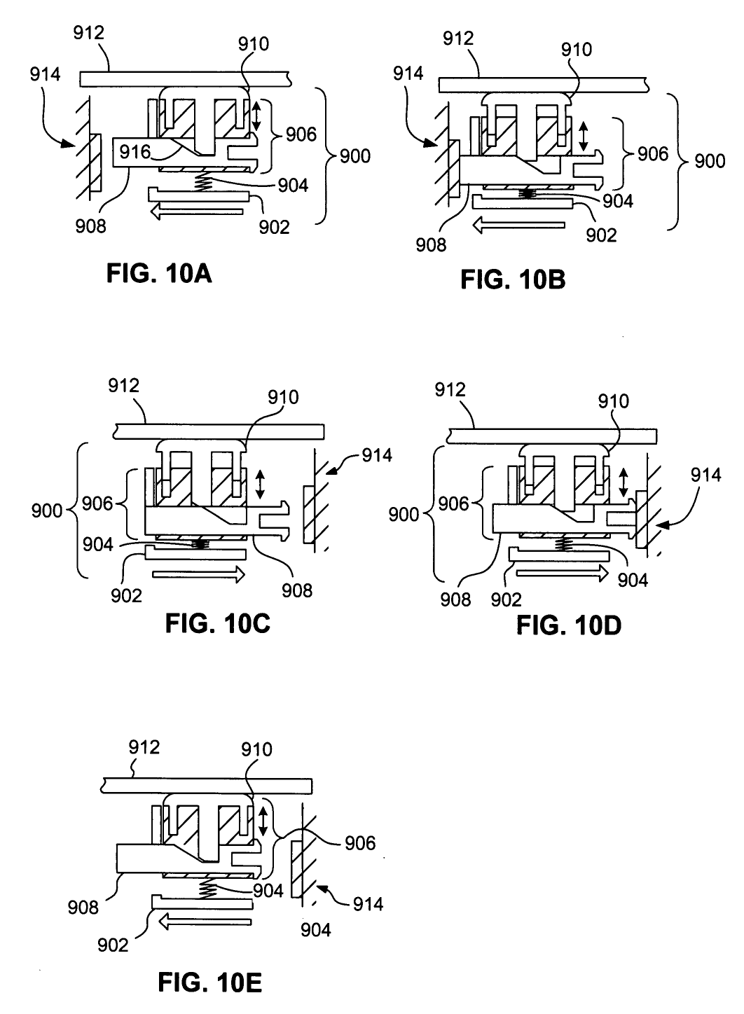

Defocusing the image sensor may be accomplished by adjusting the total optical path between the document to be scanned and the image sensor. This may be accomplished by adjusting the relative positions of the document to be scanned and the image sensor. With the orientation of the components shown in the FIG. 9 or 10, the image sensor is moved in a Y direction. Defocusing the image sensor may also be accomplished by inserting one or more optical elements, such as lenses, between the document to be scanned and the image sensor, thereby increasing or decreasing the total optical path between the document to be scanned and the image sensor. Other methods of defocusing the image sensor and/or adjusting the total optical path between the document to be scanned and the image sensor, as are commonly known in the art, may also be used.

Removal of the high frequency information may adversely impact the quality of the resultant scanned image as some of the original image content is lost in the filtering process. However, this impact is negligible. While a small portion of original image content is lost, the net result is an overall improvement in the quality of the resultant scanned image due to the reduction in aliasing. The impact of the loss of high frequency information is negligible because, in general, default scan modes are typically low resolution. As such, detailed, high frequency information is not picked up by the scanner and does not contribute to improving the overall quality of the resultant image. Thus, the only effect high frequency information has on the resultant image is to promote aliasing which detracts from the quality of the resultant image. Therefore, even though some original image information is lost in the removal of high frequency image information, the end result is an improved scanned image because aliasing is reduced or in some cases eliminated.

The method of reducing aliasing by removing high frequency information by defocusing the image sensor is applicable to various scanner types including flat bed scanners, feed scanners, and the like. The method is also applicable to scanner systems employing different types of optical sensors. However, the method is best suited to contact image sensor (CIS) scanners.

CIS devices have a very shallow depth of field (DOF). Therefore, a small change in the position of the CIS relative to the document to be scanned causes sufficient blurring in the resultant scanned image to substantially remove aliasing while preserving lower frequency valid image data. FIG. 5 shows a illustrative, representative sketch of depth of field for a typical CIS as a function of distance with the zero on the X axis being the nominal focal depth. The negative numbers on the X axis indicate moving the scan bar closer to the document to be scanned while the positive numbers indicate moving the scan bar away from the document. On the Y axis the depth of field is measured in terms of the Modulation Transfer function (MTF), a measure of how well high frequency data is preserved in an image. The MTF is dependent on the specific sampling frequency used to perform the scan as well as the input spatial frequency of the document or target to be scanned. As illustrated, the maximum MTF occurs at the nominal focal depth and decreases as the distance from the document decreases or increases. FIG. 5 shows that, for a CIS device, the MTF drops off rapidly when the CIS device is moved only a small distance about its nominal focal position.

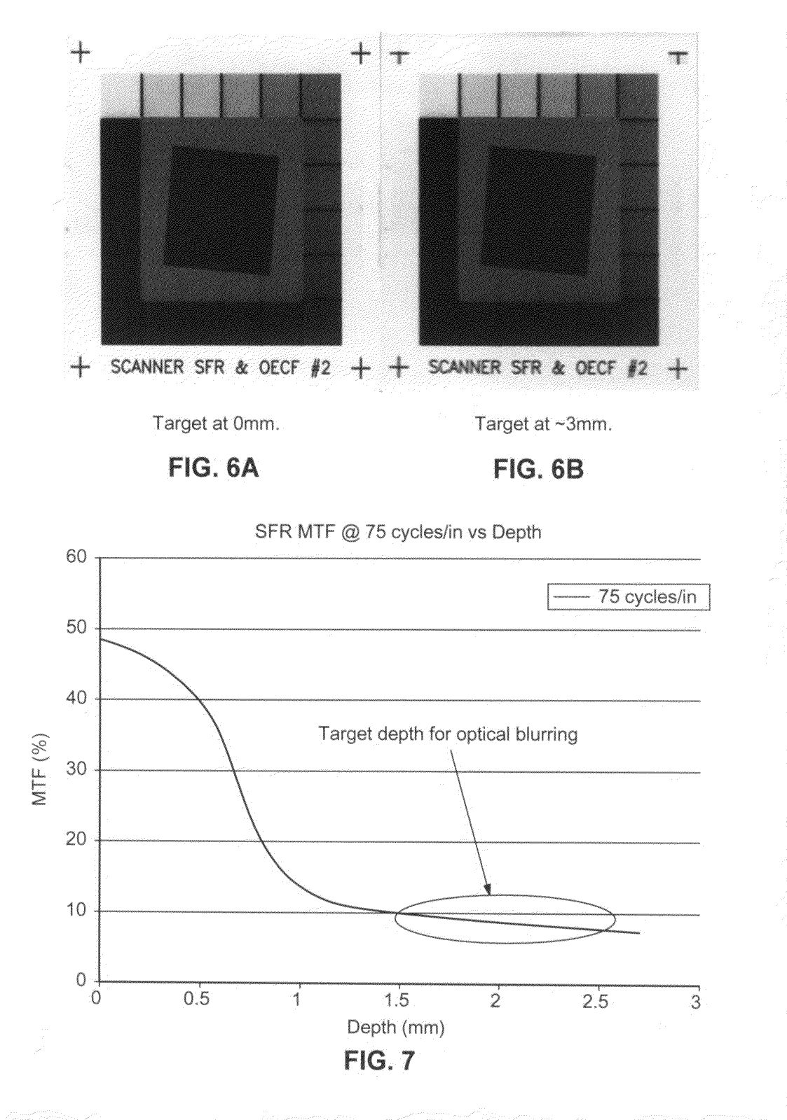

The visual effect of the shallow depth of field of the CIS is shown in FIGS. 6A and 6B. FIG. 6A was obtained at 0 mm (nominal focal depth or the focused position) while the image in FIG. 6B was obtained at approximately 3 mm. As shown in FIG. 6B, changing the position of the CIS sensor blurs the resultant scanned image as can be seen in the text of that image.

The appropriate depth with which to place the CIS relative to the document to be scanned to cause blurring and reduce aliasing without destroying the image can be determined experimentally. This is done by taking optical scans of a target image under varying conditions and analyzing the data to find the most appropriate range to use.

Scans of a Spatial Frequency Response (SFR) target were taken at a default scan mode resolution (fₛ) of 150 dpi (dots per inch). Because fₛ must be greater than 2fₕ in order to prevent aliasing, the highest frequency component of the image that can be accurately reproduced without aliasing in the resultant image is fₕ=fₛ/2 or 75 cycles per inch. Therefore, by plotting the MTF versus Depth at 75 cycles/inch, it is possible to determine a CIS position where the MTF becomes relatively stable. Referring to FIG. 7, the MTF becomes relatively stable at about 10% for a depth of about 1 mm to about 3 mm. Having a stable MTF over a range of depths provides for continuity and repeatability in the filtering process as small changes in the CIS position will not cause significant additional blurring in the scanned image. For the experimental conditions, any depth from about 1 mm to about 3 mm about the nominal focal depth should provide blurring sufficient to reduce aliasing while also maintaining valid image content.

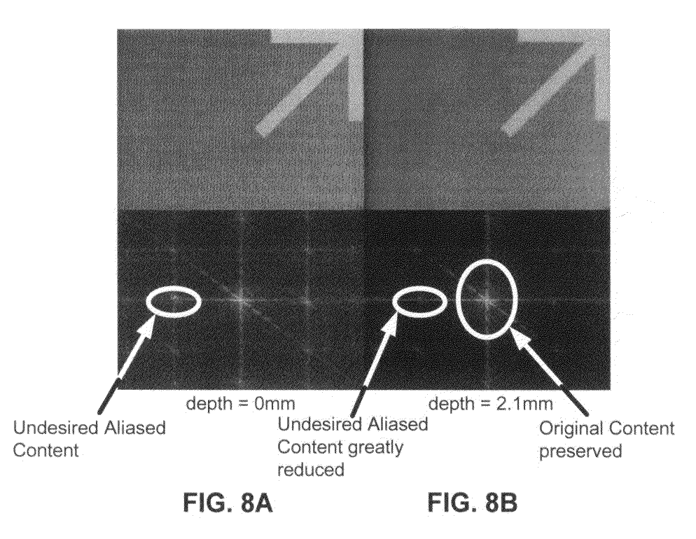

After determining an appropriate depth for optically blurring the image, scans of screen printed original content were taken at the nominal focal depth (0 mm) and at a focal depth in the determined range about the focal depth of about 1 mm to about 3 mm with the selected depth being 2.1 mm. FIGS. 8A and 8B show the results of those scans along with the FFT for each image. FIG. 8A is a scan taken at the nominal focal depth of 0 mm and exhibits undesired aliased content as indicated by the white oval in the FFT. FIG. 8B shows an image using defocused image sensor positional at a depth of 2.1 mm from the nominal depth used in FIG. 8A. The resultant scan has greatly reduced aliasing artifacts, as shown in the white oval of the FFT for FIG. 8B as compared to that in the focused image FFT of FIG. 8A while the original content is preserved in the defocused scan. The relative reduction in aliasing for the images shown in FIGS. 8A and 8B is at least 86%.

Accordingly, one exemplary embodiment of the method of the present invention comprises performing a scan of screen printed original content with the image sensor of the scanner defocused so as to filter and remove high frequency image information from the resultant image. While the method causes some blurring of the resultant scanned image, the overall quality of the image is improved. The method is applicable to various scanner and image sensor configurations, but is best suited to image sensors having a shallow depth of field such as contact image sensors.

In another embodiment of the method, the image sensor is defocused by adjusting the distance between the image sensor and the document. In one exemplary embodiment, the image sensor is defocused by moving the image sensor so as to increase the distance between the document and the image sensor.

In another embodiment of the method, prior to scanning the document with the image sensor in the defocused position, a pre-scan of the document is performed with the image sensor in the focused position. The pre-scan utilizes a screen detection algorithm to determine if the document being scanned will benefit from filtering high frequency image content. If the document will benefit from filtering high frequency image content, the image sensor is moved to the defocused position and the scan is performed. If the document will not benefit from the filtering of high frequency image content, the document is scanned with the image sensor in the focused position.

Another aspect of the invention is an adjustable scan bar assembly for reducing aliasing in screen printed original documents for use in conjunction with a scanner. Referring to FIG. 9, the assembly 900 comprising a scan bar 906 having an image sensor (not shown) disposed in the housing 914 of a scanner. The scan bar 906 is positioned on a chassis 902 which facilitates the lateral (X axis) movement of the scan bar relative to the scan bed 912. An actuator 940 is positioned between the scan bar 906 and the chassis 902. The actuator 940 adjusts the vertical position (Y axis) of the scan bar 902 relative to the scan bed 912 and about the nominal focal depth thereby focusing or defocusing the image sensor (not shown). The actuator 940 may be mechanically or electrically actuated.

FIGS. 10A-E show an exemplary embodiment of the adjustable scan bar assembly. The assembly 900 comprises a scan bar 906 containing an image sensor (not shown). The scan bar 906 is located on a chassis 902. The chassis 902 facilitates the lateral (X axis) movement of the scan bar 906 with respect to the scan bed 912. At least one bias spring 904 is disposed between the chassis 902 and the scan bar 906. The bias spring provides spring tension between the scan bar assembly 900 and the glass scan bed 912 of the scanner. At least one switch 908 is slidably disposed through the scan bar 906 such that the switch 908 is free to move laterally through the scan bar 906. At least one slider 910 is positioned atop the scan bar 906 and is adjustably engaged, for example, using the illustrated channel and rail arrangement with the scan bar 906 such that the position of the scan bar 906 along the slider 910 can be adjusted relative to the scan bed 912. A portion of the slider 910 extends through an opening in the scan bar 906 and has a partially tapered or partially beveled end that is mechanically engaged in the sloped opening 916 provided in switch 908. The slider 910, in conjunction with the bias spring 904, maintains the parallel orientation of the scan bar 906 with respect to the scan bed 912. The bias spring 904 provides tension to the slider 910 thereby maintaining the scan bar assembly 900 in the selected state.

The adjustable scan bar assembly for reducing aliasing in screen printed original documents operates in two modes: focused and defocused. Each mode is dependent upon the position of the switch 908. FIGS. 0A and 10E show the assembly in focused mode. Specifically referring to FIG. 10A, in focused mode, the switch 908 is positioned to the left and fully engaged with the scan bar 906 with a head portion 918 abutting the scan bar 906. In this position, the biasing spring 904 is fully extended thereby forcing the scan bar 906 upwards, towards the scan bed 912, until the channels of scan bar 906 are fully engaged with the rails provided on slider 910. The rails of the slider 910 extending into the channels of the scan bar 906 acts as guides for repositioning the scan bar 906. When the scan bar 906 is fully engaged with the slider 910, the image sensor located on the scan bar 906 is focused.

FIG. 10C shows the assembly in defocused mode. In defocused mode the switch 908 is positioned to the right and only partially engaged with the scan bar 906. In this position, the slider 910, which is rigidly bounded on one side by the scan bed 912, exerts a downward force on the on the switch 908. This downward force is communicated to the scan bar 906 which becomes partially disengaged from the slider 910 as it forced down the slider 910 and away from the scan bed 912. As the scan bar 906 moves away from the scan bed 912, the image sensor (not shown) of the scan bar 906 becomes defocused. When the scan bar 906 reaches the furthest position from the scan bed 912, the image sensor (not shown) is in a pre-determined defocused position for filtering high frequency image content from screen printed originals while preserving valid image data.

The sequence of FIGS. 10A-10E shows one form of mechanism that can be employed to move the adjustable scan bar assembly from a focused mode to a defocused mode and back to the focused mode. The horizontal arrow beneath each figures indicates the direction of motion of the scan bar assembly 900 within the scanner housing during the scanning of a document. The double headed arrow shows the direction of the relative motion between the either the scan bar or image sensor and either the scan bed or the document to be scanned.

FIGS. 10A-10C shows the scan bar 906 moving from focused mode to defocused mode. FIG. 10A shows the scan bar 906 in a focused position moving toward housing 914 of the scanner and preparing to switch to a defocused mode. FIG. 10B shows the assembly in the process of being switched from focused to defocused modes. The switch 908 is actuated when the motion of the chassis 902 causes the switch 908 to mechanically contact the housing 914. As the switch 908 slides through the scan bar 906, the switch 908 reacts against the slider 910, forcing the switch 908 and scan bar 906 down, towards the chassis 902 and away from the scan bed 912, and starting to compress the biasing spring 904. FIG. 10C shows the assembly in the defocused mode with the slider 910 on top of switch 908 with biasing spring 904 at maximum compression.

FIGS. 10C-10E show the assembly being switched from defocused to focused modes. In FIG. 10D the switch 908 is actuated when movement of the chassis 902 brings the switch 908 in contact with the housing 914. As the switch 908 slides back through the scan bar 906, the downward force exerted by the slider 910 on the switch 908 and the scan bar 906 is decreased as the slider 910 is repositioned in the sloped opening 916 along the switch 908. The reduction in downward force allows the bias spring 904 to extend, thereby exerting a force against the scan bar 902 which moves the scan bar 902 upwards, until it is at FIG. 10E completely reengaged with the slider 910 and in the focused position.

The scan bar assembly shown in FIGS. 10A-E can be used to carry out the method of reducing aliasing in screen printed original documents as follows. Starting with the scan bar assembly in the focused position, the switch 908 is actuated and the scan bar assembly 900, including the image sensor, is defocused. A scan of the screen printed original document located on the scan bed 912 is performed. The switch 908 is actuated a second time and the scan bar assembly 900 is returned to the focused position.

In another embodiment, prior to defocusing the scan bar assembly 900, a pre-scan of the document is performed with the image sensor in the focused position. The pre-scan utilizes a screen detection algorithm to determine if the document being scanned will benefit from filtering high frequency image content. If the document will benefit from filtering high frequency image content, the switch 908 is actuated and the scan bar assembly 900 is placed in the defocused position and the scan is performed. If the document will not benefit from the filtering of high frequency image content, the document is scanned with the image sensor in the focused position.

The foregoing description of several methods and an embodiment of the invention has been presented for purposes of illustration. It should be understood that the techniques described herein may also be used with a scanning apparatus used with an automatic document feeder where the document is transported across a scan bar that is substantially fixed in the scan direction but which is capable of movement to adjust the nominal focal distance of the image sensor. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method of reducing aliasing in a scan of a screen printed original document comprising removing high frequency image information at an input of an image sensor prior to scanning, the image sensor having a nominal focal position and a total optical path at a distance from the original document.

2. The method of claim 1 wherein the act of removing high frequency image information comprises defocusing the image sensor by adjusting the total optical path between the image sensor and the original document.

3. The method of claim 2 wherein the adjusted total optical path between the image sensor and the original document is from approximately 1.0 mm to approximately 3.0 mm about the nominal focal position of the image sensor.

4. The method of claim 2 wherein adjusting the total optical path comprises moving the image sensor relative to the original document.

5. The method of claim 2 wherein adjusting the total optical path comprises moving the original document relative to the image sensor.

6. The method of claim 2 wherein the total optical path is adjusted optically.

7. The method of claim 2 wherein the adjusted total optical path is adjusted about the nominal focal position of the image sensor.

8. The method of claim 1 further comprising performing a pre-scan of the original document using a screen detection algorithm to determine if aliasing will occur when scanning.

9. The method of claim 1 wherein, after scanning, the amount of aliasing is reduced by at least 80%.

10. The method of claim 1 wherein, after scanning, the scan has a Modulation Transfer Function of about 10% for a sampling frequency and an input spatial frequency used in scanning the screen printed original document.

11. A method of reducing the effects of aliasing in a scan of a document with a scanner, the scanner having a scan bar with an image sensor disposed thereon, the image sensor having a nominal focal position relative to the document to be scanned, the method comprising:
determining if aliasing will occur;
if aliasing will occur, defocusing the image sensor from the nominal focal position; and
scanning the document with the image sensor in the defocused position.

12. The method of claim 11 wherein defocusing the image sensor comprises repositioning the image sensor from approximately −1.0 mm to approximately +3.0 mm about the nominal focal position of the image sensor.

13. The method of claim 11 wherein defocusing the image sensor comprises repositioning one of the document to be scanned and the scan bed from approximately −1.0 mm to approximately +3.0 mm about the nominal focal position of the image sensor.

14. The method of claim 11 wherein the image sensor is defocused by moving one of the scan bar and the document.

15. The method of claim 11 wherein the scan has a reduction in aliasing of at least 80%.

16. The method of claim 11 wherein the scan has a Modulation Transfer Function of about 10% for a sampling frequency and an input spatial frequency used in scanning the screen printed original document.

17. The method of claim 11 in which determining if aliasing will occur includes performing a pre-scan of the document using a screen detection algorithm.

18. An adjustable scan bar assembly for a scanner, the scanner having a scan bed, the assembly comprising:
a scan bar having an image sensor having a nominal focal position used for focused scanning, the scan bar positioned on a chassis for facilitating lateral movement of the scan bar relative to the scan bed of the scanner; and
a mechanism positioned between the scan bar and the chassis for moving the scan bar relative to the scan bed such that the image sensor moves relative to the scan bed between a focused position and a defocused position.

19. The assembly of claim 18 wherein the image sensor is a contact image sensor.

20. The assembly of claim 18 wherein the scan bar is movable such that the focal position of the image sensor varies between about −1 mm to about +3 mm from the nominal focal position.

21. The assembly of claim 18 wherein the mechanism is one of a mechanical actuator, an electrical actuator, and a slideable switch.
